(19) United States
(12) Patent Application Publication
(10) Pub. No.: US 2016/0024738 A1
(43) Pub. Date: Jan. 28, 2016

(54) VIBRATIONAL SOIL IMPROVEMENT

(71) Applicant: Christopher Allen Caldwell, Fulshear, TX (US)

(72) Inventor: Christopher Allen Caldwell, Fulshear, TX (US)

(21) Appl. No.: 14/340,326

(22) Filed: Jul. 24, 2014

(51) Int. Cl. E02D 3/00; E02D 3/046

(52) U.S. Cl. CPC E02D 3/005; E02D 3/046; B09C 2101/00

(57) ABSTRACT

Embodiments of methods, systems and apparatuses for vibrational soil mixing are described. In an embodiment, a method may include positioning a vibrational mixer relative to a region of soil to be mixed, the vibrational mixer comprising a vibration unit and a soil mixing unit. The method may also include causing the vibration unit to supply vibrational energy to the region of soil to be mixed. Additionally, the method may include causing the soil mixing element to mix the soil in the region of soil to be mixed.

### FIELD

This disclosure relates generally to soil mixing, and more specifically, to vibrational soil improvement by soil mixing with the aid of vibration energy.

### BACKGROUND

Soil mixing is a ground improvement technique used for strengthening weak soils or remediating contaminated soils by mixing/blending binders, slurries, or other types of reagents, in situ. Soil mixing processes are typically categorized in two groups: wet soil mixing and dry soil mixing. Additional types of soil mixing include jet grouting, compaction grouting, fracture grouting and the like. Soil mixing techniques include vertical axis mixers for mixing soil within a vertical column, and horizontal axis mixers with cutting wheels for mixing soil along a horizontal region of soil.

A soil mixing system often includes a rig with a power plant, such as an engine or motor configured to advance a mixing tool into the soil. The mixing tool may stir or separate the soil. Additionally, the mixing tool may introduce dry cement or reagents, water, other soils, or binders, such as grout, concrete slurry, or the like. One problem encountered by operators of prior soil mixing systems is that certain soils, such as dense clays or sands and the like are difficult to penetrate and mix. This causes excess wear on machinery, such as the power plant, gears or drive equipment for driving the mixing tools into the soil, and the mixing tools themselves. These components can be costly to repair or replace. Current practices to overcome these denser soil stratas are to increase moisture by introducing additional water or utilizing high pressure delivery to either help the soils reach liquid limit or aid in erosion to break up the soil particles.

One prior system for soil mixing is described in U.S. Pat. App. Pub. No. 2012/0308306 of Kruse (“Kruse”) which describes “lubricated soil mixing systems and methods.” The method described in Kruse involves injecting an additive in advance of the mixing tool for lubricating the soil for enhancing penetrability of the soil. Unfortunately, the lubrication methods is still insufficient for many applications and for many soil types. Additionally, the methods described in Kruse may be unsuitable for use with certain binders, or in certain soil improvement conditions or requirements. Additionally, the use of advanced lubricants adds to the cost of soil mixing and improvement, because the lubricant is not reusable.

### SUMMARY

Embodiments of methods, systems and apparatuses for vibrational soil mixing are described. In an embodiment, a method may include positioning a vibrational mixer relative to a region of soil to be mixed, the vibrational mixer comprising a vibration unit and a soil mixing unit. The method may also include causing the vibration unit to supply vibrational energy to the region of soil to be mixed. Additionally, the method may include causing the soil mixing element to mix the soil in the region of soil to be mixed.

In an embodiment, the method may also include dynamically controlling the position of the vibrational mixer relative to the region of soil to be mixed. Additionally, the method may include controlling the frequency of the vibrational energy supplied by the vibration unit. In some embodiments, the method may include controlling a magnitude of the vibrational energy supplied by the vibration unit. The method may also include controlling a pattern of vibrational energy supplied by the vibration unit.

In an embodiment, the method may include controlling rotation of the soil mixing element. The method may also include supplying a soil additive to the region of soil to be mixed. Additionally, the method may include controlling a pumping for supplying the soil additive.

Embodiments of an apparatus for vibrational soil improvement may include a vibration unit configured to supply vibrational energy to a region of soil to be mixed. The apparatus may also include a soil mixing unit coupled to the vibration unit, the soil mixing unit configured to mix the soil in the region of soil to be mixed.

In an embodiment, the soil mixing unit includes one or more soil mixing member, such as paddles, blades, or auger flights. In some embodiments, the apparatus may include a soil mixing unit further comprises an auger.

In an embodiment, the apparatus may include a swivel coupler coupled to at least one of the vibration unit and the soil mixing unit, the swivel coupler configured to allow passage of a soil additive and providing a conduit for a control wire coupled to the vibration unit.

The soil mixing unit further comprises a Cutter Soil Mix (CSM) device. In another embodiment the soil mixing unit further comprises a soil cutting machine configured for soil mixing in a horizontal plane.

An embodiment of a system includes a vibrational mixer. The vibrational mixer may include a vibration unit configured to supply vibrational energy to a region of soil to be mixed, and a soil mixing unit coupled to the vibration unit, the soil mixing unit configured to mix the soil in the region of soil to be mixed. The system may also include a power plant configured to generate power for driving the vibration unit and the soil mixing unit. In some embodiments, the system also includes a support structure for positioning the vibrational mixer relative to the region of soil to be mixed.

In an embodiment, the system may include a soil additive container coupled to the vibrational mixer, the soil additive container configured to supply a soil additive for mixing in the region of soil to be mixed. The system may also include a pump configured to pump the soil additive from the soil additive container to the vibrational mixer. In some embodiments, the soil additive is a dry mix additive. In other embodiments, the soil additive is a wet mix additive.

### DETAILED DESCRIPTION

The following drawings form part of the present specification and are included to further demonstrate certain aspects of the present invention. The invention may be better understood by reference to one or more of these drawings in combination with the detailed description of specific embodiments presented herein.

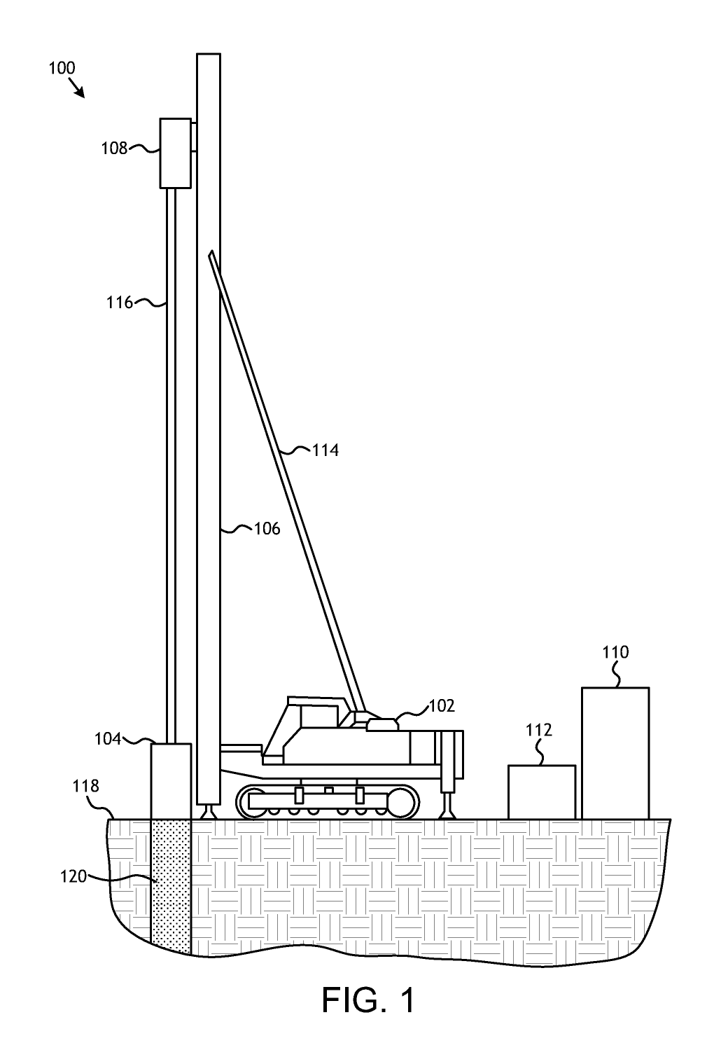

FIG. 1 is a schematic diagram illustrating one embodiment of a system for vibrational soil improvement.

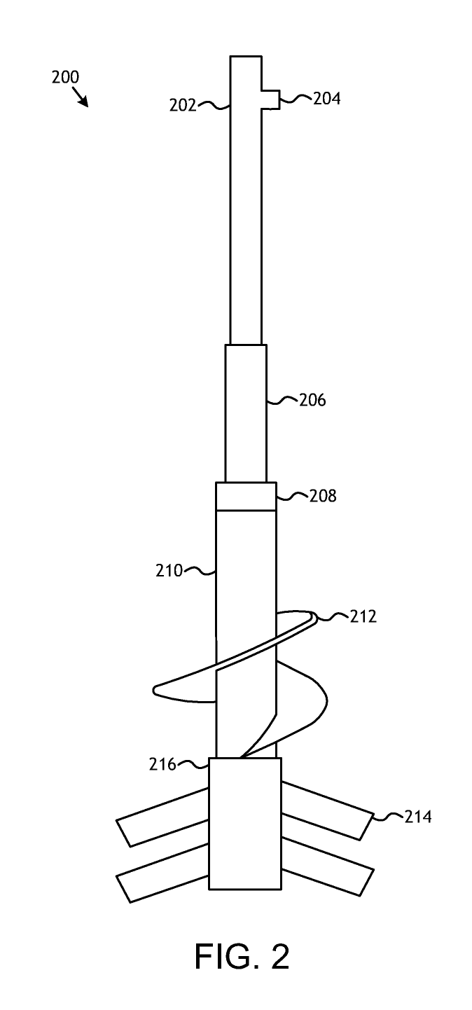

FIG. 2 is a schematic diagram illustrating one embodiment of an apparatus for vibrational soil improvement.

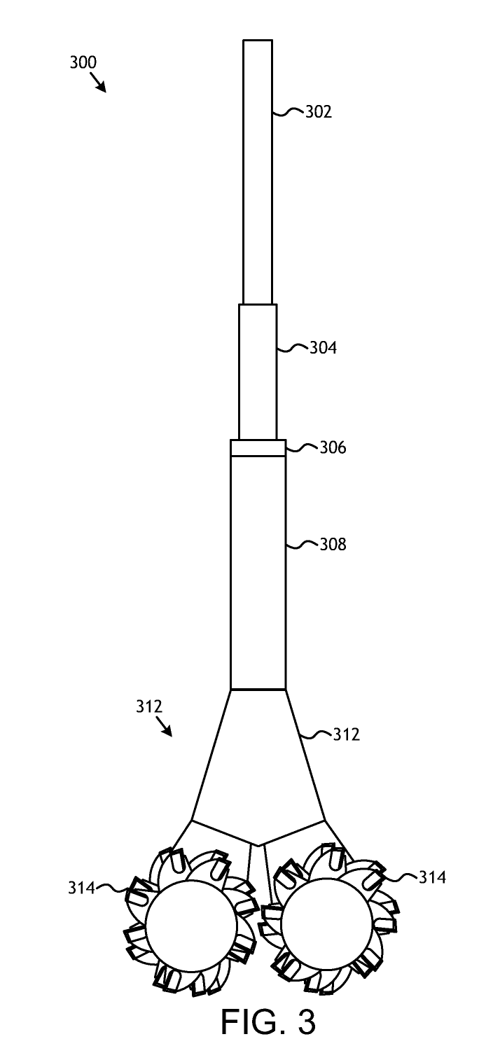

FIG. 3 is a schematic diagram illustrating another embodiment of an apparatus for vibrational soil improvement.

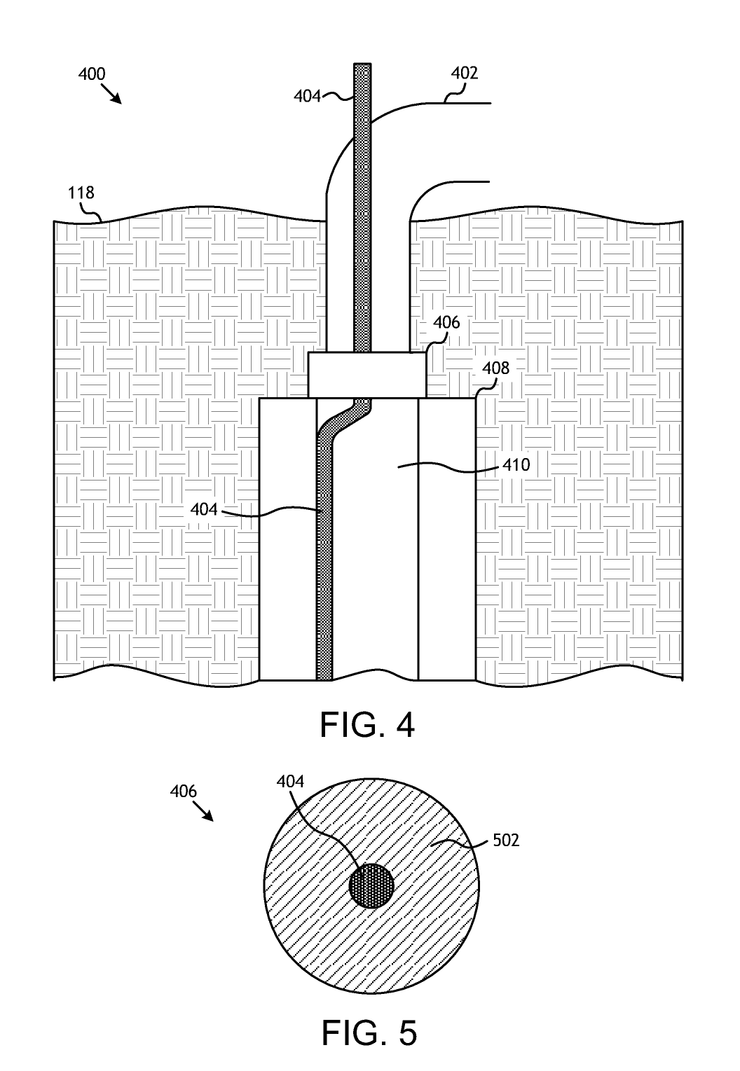

FIG. 4 is a cross-sectional diagram illustrating one embodiment of an apparatus for vibrational soil improvement.

FIG. 5 is a schematic diagram illustrating one embodiment of a swivel connector vibrational soil improvement.

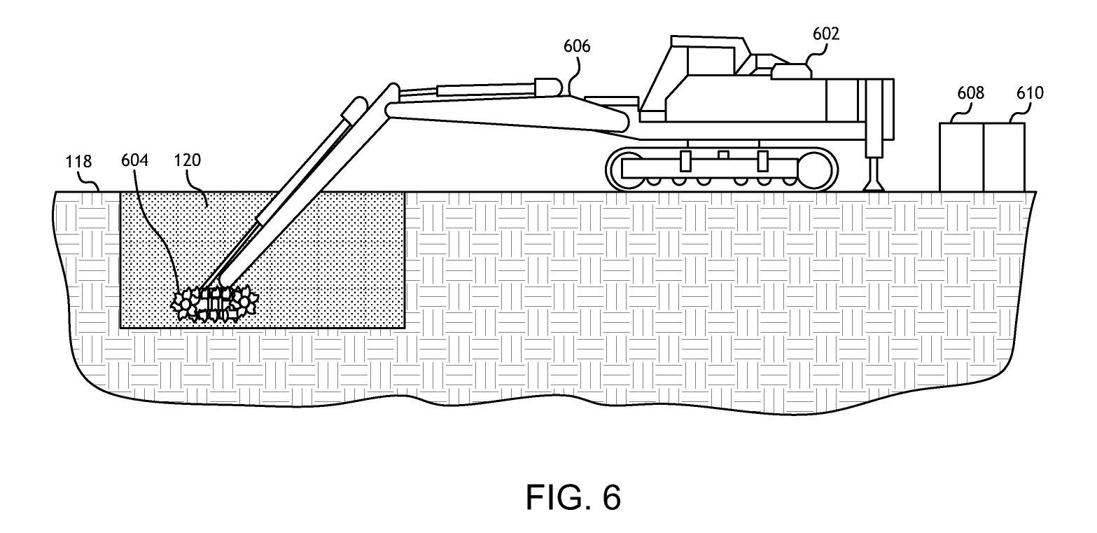

FIG. 6 is a schematic diagram illustrating another embodiment of a system for vibrational soil improvement.

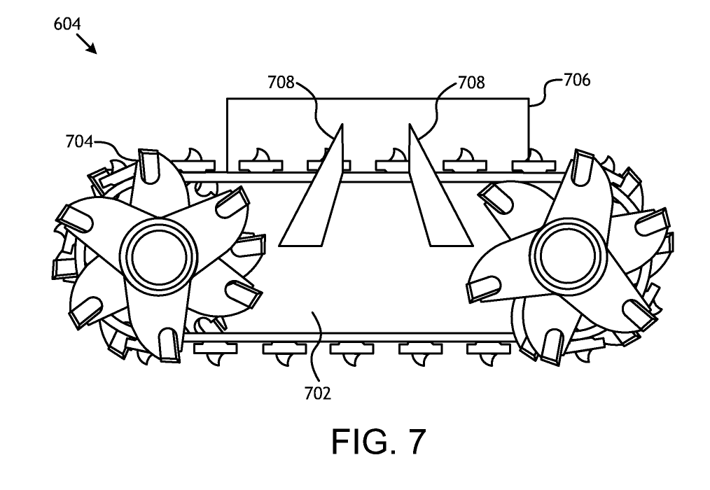

FIG. 7 is a schematic diagram illustrating another embodiment of an apparatus for vibrational soil improvement.

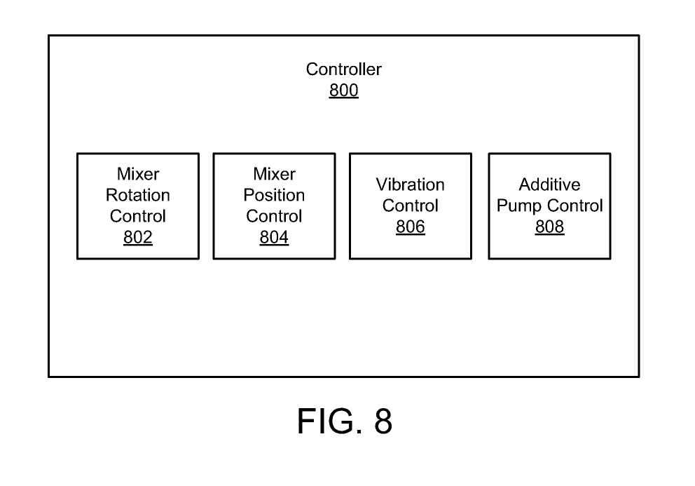

FIG. 8 is a schematic block diagram of a controller for vibrational soil improvement.

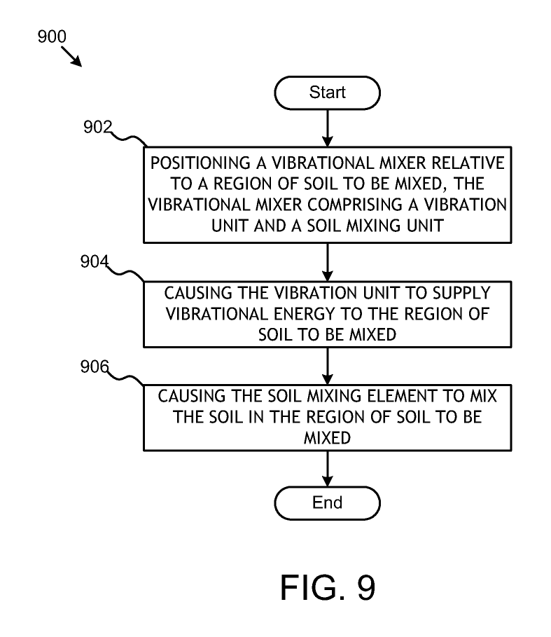

FIG. 9 is a schematic flowchart diagram illustrating one embodiment of a method for vibrational soil improvement.

### DETAILED DESCRIPTION

Various features and advantageous details are explained more fully with reference to the nonlimiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

The present embodiments include systems, methods, and apparatuses for vibrational soil improvement. In an embodiment, vibrational soil improvement may include a combination of mixing and vibration of soil. Vibrational soil improvement may further include injection of soil improvement products, such as cement, grout, and other compounds or soil additives. In still other embodiments, vibrational soil improvement may include mixing of varying soil types, such as sand, clay, silt, peat or the like in combination or alone. A vibrational soil mixing system may include a power plant, such as an engine, motor, or generator. The power plant may drive a vibration unit and a mixing unit. The power plant may additional drive a pump for distributing dry reagents, slurries, cementitious grouts, and/or the like.

Advantageously, the combination of mixing and vibration may cause a controlled state of liquefaction without the addition of excess water in certain soil types, which may facilitate deep soil mixing and penetration of soil types that are challenging to penetrate with previous and current soil mixing systems. Another advantage may include the additional compaction or consolidation of soils under and around the mixed layers. This two fold approach increases the improvement quality of achieving the desired results.

FIG. 1 is a schematic diagram illustrating one embodiment of a system 100 for vibrational soil improvement. The embodiment of FIG. 1 illustrates a vertical mixing system which may mix soil along a vertical-axis column. The system 100 may include a power plant 102 for powering portions of the system and for driving the vibrational mixer 104. Additionally, the system 100 may include a leader 106 for guiding the vibrational mixer 104, and an auger drive 108 for rotating the vibrational mixer 104 in response to power provided by the power plant 102. In an embodiment, the system 100 may include a soil additive container 110 and a pump 112 for pumping the soil additive from the soil additive container 110 through an additive pipe 114 to the drive shaft 116. The vibrational mixer 104 may penetrate the soil 118 to form a mixed soil region 120. In certain embodiments, the mixed soil region 120 may be a column along an axis of the drive shaft 116. In other embodiments, the mixed soil region 120 may be of alternative geometries.

In an embodiment, the power plant 102 may be a drilling rig, a backhoe, a tractor, a generator, or the like. The power plant 102 may be transportable in some embodiments. In some embodiments, the power plant 102 may provide electrical power for driving the vibrational mixer 104. In some embodiments, the power plant 102 may provide mechanical power for driving the vibrational mixer 104. In some embodiments, the power plant 102 may provide both electrical and mechanical power for driving the vibrational mixer 104. Additionally, the power plant 102 may provide power for driving other components of the system 100, including for example, a mixer in the soil additive container 110, the pump 112, a controller, and the like. In some embodiments, the power plant 102 may include a cab, cockpit, or controller for allowing a user to control the vibrational mixer 104. Embodiments of a controller are described below with relation to FIG. 8.

In an embodiment, the additive container 110 may include a slurry or grout mixer. The additive container 110 may include storage container for holding cement, grout, or other additives, lubricants, water, or soil types. The pump 112 may be configured to pump the soil additive from the additive container 110 through the additive pipe 114 to the drive shaft 116. In an embodiment, the drive shaft 116 may include a hollow or annular portion configured to allow passage of the soil additive to the vibration mixer 104.

The present embodiments may be used to perform methods for dry soil mixing, wet soil mixing, jet grouting, fracture grouting, soil compaction, and the like. One of ordinary skill will recognize the various methods with which the present embodiments may be implemented, and the details of implementation are recognizable to one of ordinary skill. For example, the present embodiments may be used for dry soil mixing, where the power plant provides mechanical power and/or electrical power to a vibrational mixer 104. Examples of vibrational mixers 104, which may be used with the embodiment of FIG. 1 are illustrated in FIGS. 2 and 3.

Dry soil mixing is a ground improvement method that enhances soft soils, clays with high moisture, and other weak soils by mixing in dry soil additives, such as cement binders. In such an embodiment, the power plant 102 may provide mechanical power to the auger drive 108, which turns the drive shaft 116 causing rotation of the vibrational mixer 104. The auger drive 108 may be raised or lowered along the leader 106 causing the vibrational mixer 104 to penetrate the soil 118 to a desired depth. In an embodiment, the power plant 102 may additionally provide power for operating a vibrational component of the vibrational mixer 104. A dry binding agent may be pneumatically delivered or otherwise conveyed to and through the vibrational mixer 104 into the soil 118, creating a mixed soil region 120.

Wet soil mixing, commonly referred to as Deep Mixing Method (DMM), is a ground improvement method that enhances weak soils by mixing them with water, a binder slurry or other liquid soil additive. In such an embodiment, the power plant 102 may provide power to drive the auger drive 108, which turns the drive shaft 116, causing rotation of the vibrational mixer 104. Additionally, the pump 112 may pump the liquid additive, such as cement, from the additive container 110 through the vibrational mixer 104, which may mix the liquid additive into the soil 118 creating a mixed soil region 120. In another embodiment, a dry binder may be pumped through the vibrational mixer 104, and mixed with water from water jets integrated with the vibrational mixer 104. In such embodiments, the vibrations from the vibrational mixer may enhance soil penetration and may also enhance mixing and settling of the liquid additive and the soil 118.

Dry soil mixing and wet soil mixing processes are described merely for illustrative purposes. One of ordinary skill will recognize alternative methods that may be suitable for use with the present embodiments. Details of other suitable methods, such as jet grouting, are not described in detail in the interest of brevity. Nonetheless, one of ordinary skill will readily recognize how the present embodiments may be incorporated with such methods without undue experimentation, trial or testing.

FIG. 2 illustrates one embodiment of an apparatus 200 for vibrational soil improvement. In an embodiment, the apparatus 200 comprises a vibrational mixer 104 as illustrated in FIG. 1. More particularly, the apparatus 200 may include a drive shaft 202 having an additive inlet 204 for receiving soil additives from a pump 110. A junction assembly 206 may connect the drive shaft 202 to the vibration unit 210. In an embodiment, the junction assembly 206 may include a swivel 208 configured to provide rotation to the auger blades 212 and the mixing blades 214. In one embodiment, the mixing blades 214 may be coupled to a hollow kelly 216. The entire assembly of apparatus 200 may be configured to allow passage of soil additives, such as grouts, cements, sand, water, gravel, or the like to pass from the additive inlet 204 through to the soil 118.

In an embodiment, the vibration unit 210 may be coupled to the power plant 102 via an electrical connection through the swivel 208 as illustrated in FIGS. 4-5. The vibration unit 210 may include a motor configured to rotate a weight about an axis. The vibration unit 210 may generate sufficient vibration to enhance penetration of the mixing blades 214 into the soil 118. The mixing blades 214 may be configured to rotate about a longitudinal axis of the apparatus 200 for mixing the soil 118 in a mixed soil region 120. One benefit of the combination of vibration and mixing is that the mixed soil region 120 may settle or consolidate more quickly. In such embodiments, it may be difficult to remove the mixing blades from the mixed soil region 120. By operation in a reverse direction, or reversed flighted auger blades 212 may facilitate removal of the mixing blades 214 from the mixed soil region 120 where consolidation reaches high densities.

FIG. 3 is a schematic diagram illustrating another embodiment of an apparatus 300 for vibrational soil improvement. In an embodiment, the apparatus 300 comprises the vibrational mixer 104. The embodiment may be referred to as a vibrational “Cutter Soil Mix” (CSM) device. Such an embodiment, 300 may include a drive shaft 302. The drive shaft 302 may be coupled to a junction assembly 304, which may include a swivel 306 in some embodiments. The junction assembly 304 may be coupled to a vibration unit 308. The vibration unit 308 may be coupled to a CSM mixer 312, which comprises a gear and sensor housing 312 and one or more mixer/cutter blades 314. Use of the vibration unit 308 in combination with the CSM mixer 312 may enhance soil penetration.

FIG. 4 is a cross-sectional diagram illustrating one embodiment of an apparatus 400 for vibrational soil improvement. In an embodiment, the apparatus 400 includes a passage 402 for receiving soils, additives, air or water. Additionally, a wire bundle 404 may pass through the passage 402 for conducting electrical power and/or control signals from the power plant 102 to the vibrational unit 210. In one embodiment, the apparatus 400 may include a swivel 406 configured to facilitate manipulation of a hollow Kelly 408. The hollow kelly 408 may also include an interior passage way 408 for allowing slurries, additives, air or water to pass. Additionally, passage way 410 may allow passage of the wire bundle 303. The hollow may be coupled to the swivel device 406, which may comprise an annular fitting as shown in FIG. 5. The annular fitting may include a passage way 502 for slurries, additives, air or water and for the wire bundle 404. In an embodiment, the swivel 406 may facilitate rotational movement of the hollow kelly 408.

FIG. 6 is a schematic diagram illustrating another embodiment of a system 600 for vibrational soil improvement. In the depicted embodiment, the system 600 may be configured for horizontal soil mixing. The system 600 may include a power plant 602 configured to supply power to the vibrational mixer 604. The vibrational mixer 604 may be positioned by a carrier arm 606 which may be driven by the power plant 602 in one embodiment. Additionally, the system 600 may include a pump 608 and an additive container 610. The carrier arm 606 may position the vibrational mixer 604 within the soil 118 to form a mixed soil region 120. Embodiments of a vibrational mixer 604, which may be used according to the embodiment of FIG. 6 is illustrated in FIG. 7.

The vibrational mixer 604 of FIG. 7 may comprise a soil cutting machine 702. In such an embodiment, a vibration unit 706 may be coupled to the soil cutting machine 702 by one or more couplers 708. Alternatively, the vibration unit 706 may be welded or otherwise integrated with the soil cutting machine 702. The vibration unit 706 may operate to enhance the soil penetration of the soil cutting elements 704 of the soil cutting machine 702. Soil cutting elements may include, for example, teeth, blades, tread, or other protrusions configured to cut and mix the soil 118 by relative motion in order to form a mixed soil region 120. In a further embodiment, soil additives may be injected in combination with the soil cutting performed by the soil cutting machine 702. The vibration unit 706 may enhance the process of blending and consolidating or compacting the soil additives.

FIG. 8 is a schematic block diagram of a controller 800 for vibrational soil improvement. Embodiments of the controller 800 may be integrated with the power plant 102, 602. In an embodiment, the controller 800 includes a mixer rotation control unit 802, a mixer position control unit 804, a vibration control unit 806, and an additive pump control unit 808. One of ordinary skill will recognize additional units that may be included in the controller 800 and additional functions, which may be accomplished with the controller 800.

In an embodiment, the mixer rotation control unit 802 may be configured to control a rotation of the vibrational mixer 104. For example, the mixer rotation control unit 802 may be configured to cause the power plant 102 to provide mechanical power to the auger drive 108, causing rotation of the drive shaft 116, which may cause rotation of the mixing paddles 214 or rotation of the mixing blades 314 in various embodiments. In other embodiments, the mixer rotation control unit 802 may control rotation of blades or tread in the vibrational mixer 604 of FIG. 6. The mixer rotation control unit 802 may control electrical power or mechanical power provided by the power plant 602 to the vibrational mixer 604, in various embodiments.

The mixer position control unit 804 may control a position of the vibrational mixer 104, 604, with relation to the soil 118. For example, the position control unit 804 may control the position of the auger drive 108 along the leader 106. In another embodiment, the position control unit 804 may control a position of the carrier arm 606. In some embodiments, the mixer position control 804 may control the depth of the vibrational mixer 104 along a single axis. In other embodiments, the mixer position control unit 804 may control the position of the vibrational mixer 604 within a three-dimensional space.

In an embodiment, the vibration control unit 806 may control the vibration energy generated by the vibration unit 210, 308, 706. In some embodiments, the vibration control unit 806 may control the magnitude of power for controlling the intensity of vibration of the vibration unit 210, 308, 706. In other embodiments, the vibration control unit 806 may control a frequency of vibration. In still other embodiments, the vibration control unit 806 may control a pattern of vibration, such as with intermittent pauses, variable frequencies, or variable magnitudes.

In an embodiment, the additive pump control unit 808 may control pumping of additives into the soil by pump 112, 608. In some embodiments, the pump control unit 808 may control the rate of pumping. In other embodiments, the additive pump control unit 808 may turn on or turn off pumping. In still other embodiments, the additive pump control unit 808 may control the type of additive being pumped at a given time. For example, the additive pump control unit 808 may selectively control whether water, air, soils, grouts or cements are mixed into the soil when multiple additives are provided.

FIG. 9 is a schematic flowchart diagram illustrating one embodiment of a method 900 for vibrational soil improvement. In an embodiment, the method 900 starts at block 902 with positioning a vibrational mixer relative to a region of soil to be mixed, the vibrational mixer comprising a vibration unit and a soil mixing unit. At block 904, the method 900 includes causing the vibration unit to supply vibrational energy to the region of soil to be mixed. At block 906, the method includes causing the soil mixing element to mix the soil in the region of soil to be mixed.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A method, comprising:
positioning a vibrational mixer relative to a region of soil to be mixed, the vibrational mixer comprising a vibration unit and a soil mixing unit;
causing the vibration unit to supply vibrational energy to the region of soil to be mixed; and
causing the soil mixing element to mix the soil in the region of soil to be mixed.

2. The method of claim 1, further comprising dynamically controlling the position of the vibrational mixer relative to the region of soil to be mixed.

3. The method of claim 1, further comprising controlling the frequency of the vibrational energy supplied by the vibration unit.

4. The method of claim 1, further comprising controlling a magnitude of the vibrational energy supplied by the vibration unit.

5. The method of claim 1, further comprising controlling a pattern of vibrational energy supplied by the vibration unit.

6. The method of claim 1, further comprising controlling rotation of the soil mixing element.

7. The method of claim 1, further comprising supplying a soil additive to the region of soil to be mixed.

8. The method of claim 7, further comprising controlling a pumping for supplying the soil additive.

9. An apparatus comprising:
a vibration unit configured to supply vibrational energy to a region of soil to be mixed; and
a soil mixing unit coupled to the vibration unit, the soil mixing unit configured to mix the soil in the region of soil to be mixed.

10. The apparatus of claim 9, wherein the soil mixing unit further comprises one or more soil mixing member.

11. The apparatus of claim 9, wherein the soil mixing unit further comprises an auger.

12. The apparatus of claim 9, further comprising a swivel coupler coupled to at least one of the vibration unit and the soil mixing unit, the swivel coupler configured to allow passage of a soil additive and providing a conduit for a control wire coupled to the vibration unit.

13. The apparatus of claim 9, wherein the soil mixing unit further comprises a Cutter Soil Mix (CSM) device.

14. The apparatus of claim 9, wherein the soil mixing unit further comprises a soil cutting machine configured for soil mixing in a horizontal plane.

15. A system comprising:
a vibrational mixer comprising:
a vibration unit configured to supply vibrational energy to a region of soil to be mixed; and
a soil mixing unit coupled to the vibration unit, the soil mixing unit configured to mix the soil in the region of soil to be mixed; and
a power plant configured to generate power for driving the vibration unit and the soil mixing unit.

16. The system of claim 15, further comprising a soil additive container coupled to the vibrational mixer, the soil additive container configured to supply a soil additive for mixing in the region of soil to be mixed.

17. The system of claim 16, further comprising a pump configured to pump the soil additive from the soil additive container to the vibrational mixer.

18. The system of claim 16, wherein the soil additive is a dry mix additive.

19. The system of claim 16, wherein the soil additive is a wet mix additive.

20. The system of claim 15, further comprising a support structure for positioning the vibrational mixer relative to the region of soil to be mixed.
